(19) United States
(12) Patent Application Publication
(10) Pub. No.: US 2015/0298169 A1
(43) Pub. Date: Oct. 22, 2015

(54) ACTUATING VIBRATION ELEMENT ON DEVICE BASED ON SENSOR INPUT

(71) Applicant: Lenovo (Singapore) Pte. Ltd., New Tech Park (SG)

(72) Inventors: Russell Speight VanBlon, Raleigh, NC (US); John Carl Mese, Cary, NC (US); Arnold S. Weksler, Raleigh, NC (US); Rod D. Waltermann, Rougemont, NC (US)

(73) Assignee: Lenovo (Singapore) Pte. Ltd., New Techn Park (SG)

(21) Appl. No.: 14/255,282

(22) Filed: Apr. 17, 2014

(51) Int. Cl. B06B 1/00

(52) U.S. Cl. CPC B06B 1/00

(57) ABSTRACT

In one aspect, a device includes a vibration element, a microphone, an accelerometer, a processor, and a memory accessible to the processor. The memory bears instructions executable by the processor to actuate the vibration element at a first vibration level, determine whether the input conforms to a first parameter based on input from at least one of the microphone and the accelerometer, and reduce vibration from the first level to a second level responsive to a determination that the input conforms to the first parameter.

### I. FIELD

The present application relates generally to actuating a vibration element on a device based on input from one or more sensors.

### II. BACKGROUND

When a device vibrates while on e.g. a surface that is hard and/or rigid, the resulting sound can be unpleasant and distracting to those nearby. However, there are still instances where this same level of vibration may be desirable. There are currently no adequate solutions for minimizing the foregoing adverse affects while still providing such a level of vibration when appropriate.

### SUMMARY

In one aspect, a device includes a vibration element, a microphone, an accelerometer, a processor, and a memory accessible to the processor. The memory bears instructions executable by the processor to actuate the vibration element at a first vibration level, determine whether the input conforms to a first parameter based on input from at least one of the microphone and the accelerometer, and reduce vibration from the first level to a second level responsive to a determination that the input conforms to the first parameter.

In another aspect, a method includes actuating, at a device, a vibration element using a first vibration pattern, determining whether the input conforms to a first parameter based on input from at least one sensor, and altering actuation of the vibration element to a second vibration pattern different from the first vibration pattern responsive to determining that the input conforms to the first parameter.

In still another aspect, a device includes at least one sensor, a vibration element, a processor, and a memory accessible to the processor. The memory bears instructions executable by the processor to receive input from the sensor, determine whether an attribute detected by the sensor conforms to a first parameter based on the input from the sensor, and actuate the vibration element to vibrate at a first magnitude responsive to a determination that the attribute detected by the sensor conforms to the first parameter.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIGS. 3-7 and 9 are flow charts showing example algorithms in accordance with present principles;

FIG. 8 is an example data structure in accordance with present principles; and

FIGS. 10 and 11 are example user interfaces (UIs) in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

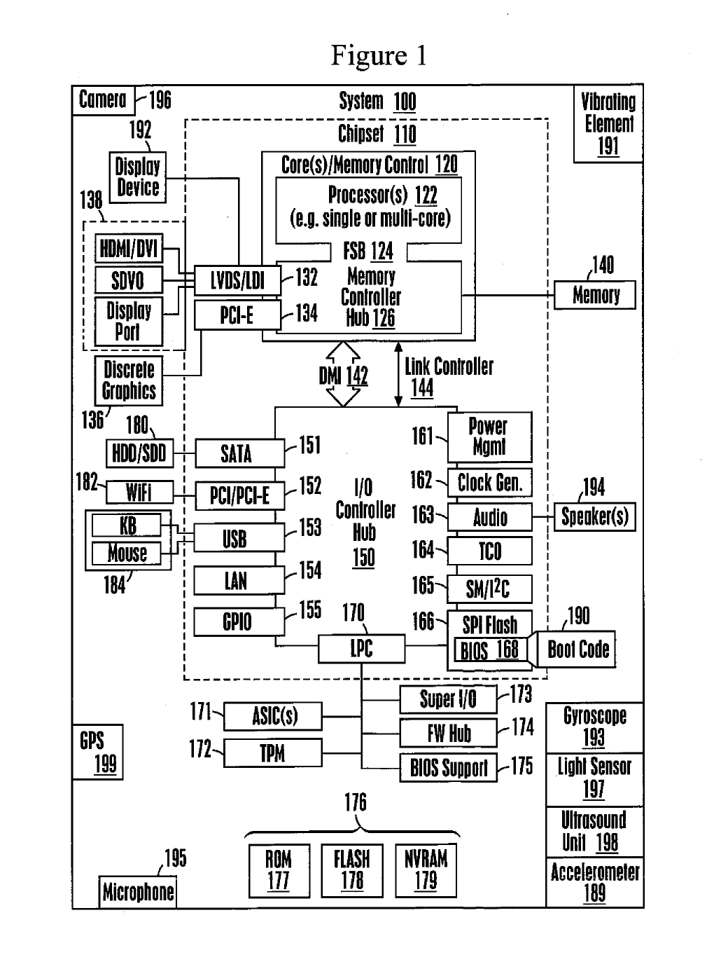

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including e.g. one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

In addition to the foregoing, the system 100 is understood to include an audio receiver/microphone 195 in communication with the processor 122 and providing input thereto based on e.g. a user providing audible input to the microphone 195. A camera 196 is also shown, which is in communication with and provides input to the processor 122. The camera 196 may be, e.g., a thermal imaging camera, a digital camera such as a webcam, and/or a camera integrated into the system 100 and controllable by the processor 122 to gather pictures/images and/or video.

Still further, the system 100 includes a vibrating element 191 that may be and/or include e.g. a motor for moving an eccentric weight of the vibrating element to generate a vibration. Moreover, in some embodiments the system 100 may include gyroscope 193 for e.g. sensing and/or measuring the orientation of the system 100, a light sensor 197 for sensing light such as e.g. ambient light, and an ultrasound unit 198 that may include e.g. an ultrasonic (e.g. piezoelectric) transducer but in any case is understood to be configured for transmitting and receiving ultrasound waves to determine the material(s) that an object through which the ultrasound waves pass and/or contact is comprised of using e.g. ultrasonic nondestructive testing.

Still in reference to FIG. 1, note that an accelerometer 189 for e.g. sensing acceleration and/or movement of the system 100 is shown, as is a GPS transceiver 199 that is configured to e.g. receive geographic position information from at least one satellite and provide the information to the processor 122. However, it is to be understood that another suitable position receiver other than a GPS receiver may be used in accordance with present principles to e.g. determine the location of the system 100.

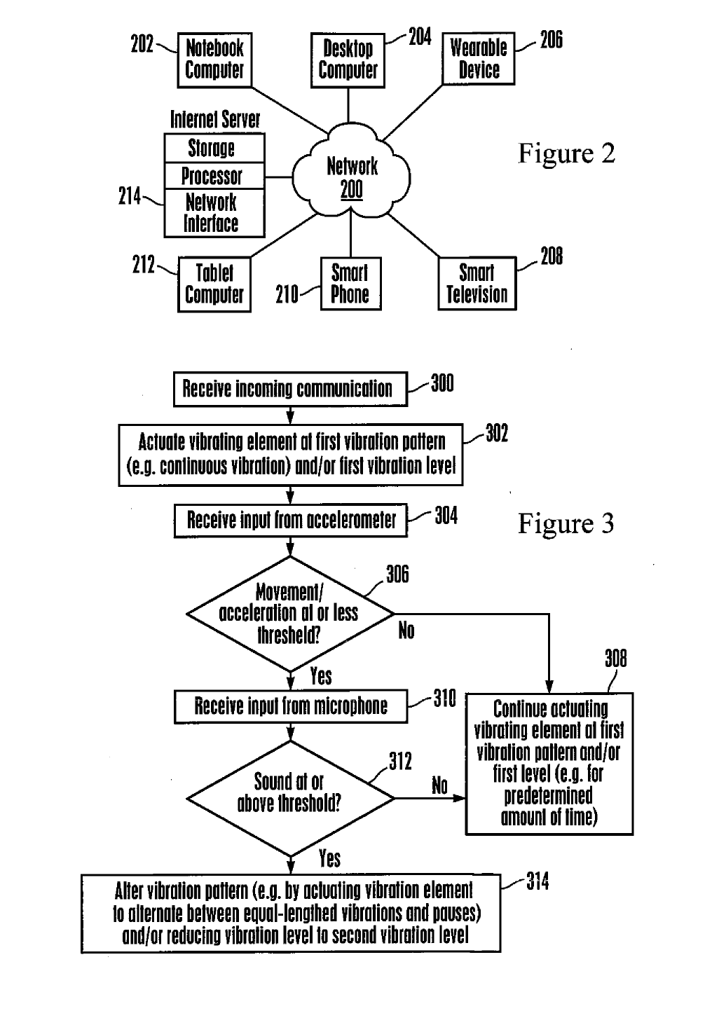

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 2120, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

Referring to FIG. 3, it shows example logic that may be undertaken by a device such as the system 100 in accordance with present principles. Beginning at block 300, the logic receives an incoming communication at the device undertaking the logic of FIG. 3 (referred to below as the “present device”). An incoming communication may be e.g. an incoming telephone call, an incoming email, an incoming text message, an incoming video chat call, an incoming social networking message, etc. Note however that in addition to or in lieu of the foregoing, also at block 300 e.g. a triggering event for activating a vibrating element in accordance with present principles may include other things such as e.g. the expiration of an alarm, the arrival time of an event on a calendar on the present device, etc.

In any case, from block 300 and responsive to the triggering event identified and/or received at block 300, the logic moves to block 302 where the logic actuates a vibration element on the first device at a first vibration level (such as e.g. a default level) and/or using a first vibration pattern (e.g. constant and/or continual vibration for a predetermined time). The logic then proceeds to block 304 where the logic receives input from an accelerometer on the present device and then at decision diamond 306 determines whether the input that was received at block 304 is indicative of movement and/or acceleration of the present device at or less than an acceleration threshold. In some embodiments, the threshold may be e.g. zero acceleration and/or movement. Also in some embodiments, the threshold may be negligible movement and/or acceleration such as movement that may be caused merely by e.g. the present device vibrating on a flat surface (e.g., movement less than one millimeter per second or movement less than one centimeter per second).

In any case, a negative determination at diamond 306 causes the logic to proceed to block 308, at which the logic continues actuating the vibrating element at the first vibration level and/or using the first vibration pattern e.g. for a predetermined amount of time such as e.g. so long as the present device “rings” responsive to an incoming telephone call. However, an affirmative determination at diamond 306 instead causes the logic to proceed to block 310, at which the logic receives input from a microphone on the present device.

From block 310 the logic proceeds to decision diamond 312, where the logic determines based on the input received at block 310 whether (e.g. ambient and/or local) sound is at or above a threshold amount. A negative determination at diamond 312 causes the logic to proceed to block 308. However, an affirmative determination at diamond 312 instead causes the logic to proceed to block 314, at which the logic alters actuation of the vibrating element by e.g. reducing the vibration level to a second vibration level and/or by changing the pattern of vibration such as e.g. changing from a constant vibration produced by the element to periodic vibrations of equal lengths separated by periods of no vibration, where the periods of no vibration are also of the same length as each other.

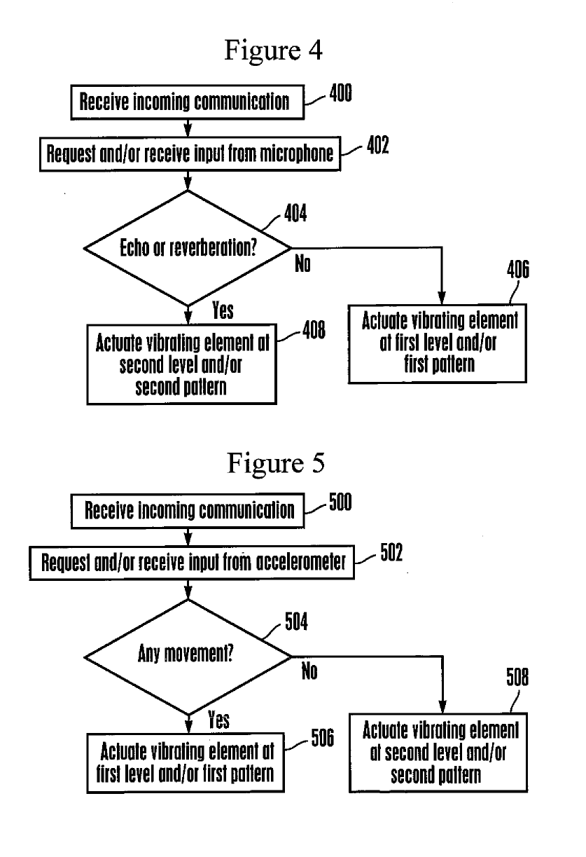

Before moving on to the description of FIG. 4, note that the thresholds discussed in reference to FIG. 3, and indeed any of the thresholds and/or parameters discussed herein, may be stored in a lookup table on the present device, where the lookup table may be accessed responsive to e.g. receiving input at either block 304 or block 310 to then compare the received input against data in the lookup table to determine if the received input reaches and/or complies with the threshold and/or parameter indicated therein for data of the same type (e.g. accelerometer input).

Furthermore, as may be appreciated from the example shown in FIG. 3, in some embodiments plural thresholds for different types of data and/or received input are to be met to cause vibration levels and/or patterns to be altered. By using plural thresholds for different types of data and/or received input in combination with each other, accuracy may be improved on instances where the vibration level may or should be reduced and/or the vibration pattern changed. E.g., if the present device, based on received input, determined that movement of the device was more than the movement threshold even though sound is also above its threshold, vibration may continue to occur at the first level and/or pattern since e.g. the user may have control over the present device (e.g. it is in the user's pocket) rather than the present device being on a table where reverberations from the present device against the table may cause a distraction and/or annoyance and/or may have otherwise caused ambient sound to reach the sound threshold.

However, as may be appreciated from many of the other figures described herein, in other embodiments only one determination may be made and/or threshold may be met to cause vibration levels and/or patterns to be altered. Thus, e.g. the determinations at diamond 306 and 312 may be executed in in isolation from other determinations to reach either of blocks 308 and 314. Moreover, as may be further appreciated from FIGS. 4-7 and 9 (which will be described shortly), a vibrating element need not necessarily be actuated at one level and/or pattern only to be subsequently changed based on a determination in accordance with present principles, but also may be initially actuated at one level or another, and/or one pattern or another, responsive to the determinations discussed herein.

Now describing FIG. 4, it shows example logic that may be undertaken by a device such as the system 100 in accordance with present principles. Beginning at block 400, the logic receives an incoming communication. The logic then proceeds to block 402 where the logic (e.g. requests and) receives input from a microphone on the device. The logic then proceeds to decision diamond 404 where, based on the input that is received at block 402, the logic determines whether the input corresponds to or is otherwise indicative of an echo or reverberation (e.g. as caused by vibrations emanating from the device, and/or caused by the device vibrating against a relatively hard surface, and detected by the microphone where those sounds may be quite distracting to a nearby person). A negative determination causes the logic to proceed to block 406, at which the logic actuates (and/or continues actuating) a vibrating element on the device at a first level and/or first pattern. However, responsive to an affirmative determination at diamond 404, the logic instead proceeds to block 408, at which the logic actuates the vibrating element at a second level and/or second pattern respectively different from the first level and first pattern, such as e.g. actuating the vibrating element at a vibration level less than the first level and/or a pattern of vibrations separated by pauses in vibration.

Continuing the detailed description in reference to FIG. 5, it shows example logic that may be undertaken by a device such as the system 100 in accordance with present principles. Beginning at block 500, the logic receives an incoming communication. The logic then proceeds to block 502 where the logic (e.g. requests and) receives input from an accelerometer on the device. The logic then proceeds to decision diamond 504 where, based on the input that is received at block 502, the logic determines whether the input corresponds to or is otherwise indicative of any movement and/or acceleration of the device e.g. greater than no or negligible movement. An affirmative determination causes the logic to proceed to block 506, at which the logic actuates (and/or continues actuating) a vibrating element on the device at a first level and/or first pattern. However, responsive to a negative determination at diamond 504, the logic instead proceeds to block 508, at which the logic actuates the vibrating element at a second level and/or second pattern respectively different from the first level and first pattern, such as e.g. actuating the vibrating element at a vibration level less than the first level and/or a pattern of vibrations separated by pauses in vibration.

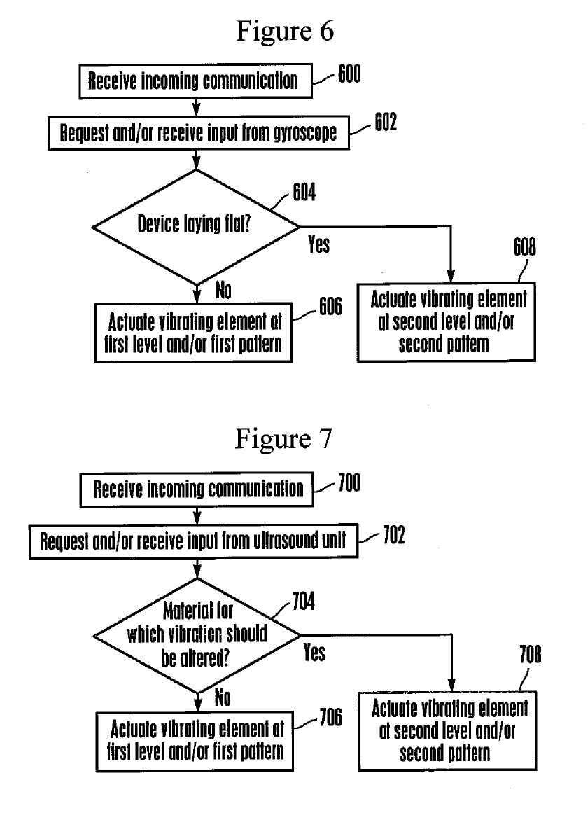

Now describing FIG. 6, it shows example logic that may be undertaken by a device such as the system 100 in accordance with present principles. Beginning at block 600, the logic receives an incoming communication. The logic then proceeds to block 602 where the logic (e.g. requests and) receives input from a gyroscope on the device. The logic then proceeds to decision diamond 604 where, based on the input that is received at block 602, the logic determines whether the input corresponds to or is otherwise indicative of the device currently being in an orientation for which vibration levels and/or patterns may or should be altered (e.g. based on predefined settings configured by a user), and/or for which vibration levels and/or patterns may or should be actuated at particular levels and/or patterns (e.g. based on predefined settings configured by a user) different than those at which the vibration element would otherwise vibrate. Thus, in some embodiments the orientation may be the device laying or placed flat against a surface (e.g. oriented such that a display of the device establishes a plane orthogonal to an axis established by the direction of the Earth's gravity at the first device).

A negative determination at diamond 604 causes the logic to proceed to block 606, at which the logic actuates (and/or continues actuating) a vibrating element on the device at a first level and/or first pattern. However, responsive to an affirmative determination at diamond 604, the logic instead proceeds to block 608, at which the logic actuates the vibrating element at a second level and/or second pattern respectively different from the first level and first pattern, such as e.g. actuating the vibrating element at a vibration level less than the first level and/or a pattern of vibrations separated by pauses in vibration.

Moving on to the description of FIG. 7, it shows example logic that may be undertaken by a device such as the system 100 in accordance with present principles. Beginning at block 700, the logic receives an incoming communication. The logic then proceeds to block 702 where the logic (e.g. requests and) receives input from an ultrasound unit on the device, such as e.g. the unit 198 described in reference to FIG. 1 above. The logic then proceeds to decision diamond 704 where, based on the input that is received at block 702, the logic determines whether the input corresponds to or is otherwise indicative of the device being juxtaposed against and/or near a material for which vibration may or should be altered, and/or for which different levels and/or patterns may or should be used than those at which a vibration element on the device would otherwise vibrate (e.g. based on a determination of a material for which vibration is not to be altered). A negative determination causes the logic to proceed to block 706, at which the logic actuates (and/or continues actuating) the vibrating element at a first level and/or first pattern. However, responsive to an affirmative determination at diamond 704, the logic instead proceeds to block 708, at which the logic actuates the vibrating element at a second level and/or second pattern respectively different from the first level and first pattern, such as e.g. actuating the vibrating element at a vibration level less than the first level and/or a pattern of vibrations separated by pauses in vibration.

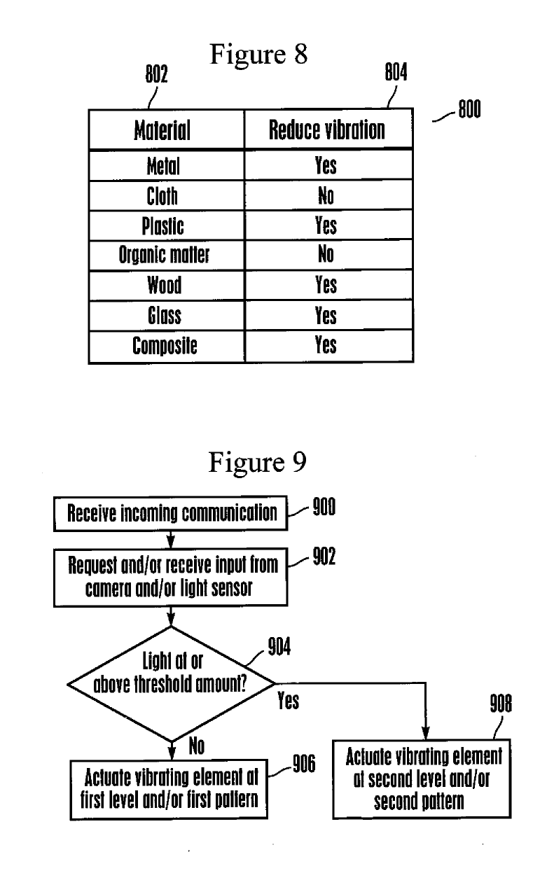

Before moving on to FIG. 8, it is to be understood that ultrasound software and/or applications may be stored on a device undertaking the logic of FIG. 7 for execution by the device's processor to determine in combination with the ultrasound unit (which transmits and receives ultrasound waves) the material(s) that an object through which the ultrasound waves pass and/or contact (e.g. materials touching or near the device) is comprised of e.g. by using ultrasonic nondestructive testing principles.

Furthermore, note that the determination at diamond 704 may be based on the device accessing a data table such as the table 800 shown in FIG. 8 so that the logic may, based on a determination of material using e.g. ultrasonic nondestructive testing principles, determine whether a detected and/or determined material is a material for which vibration may or should be altered, and/or for which a different level and/or pattern may or should be used than would otherwise be used. As may be appreciated from the table 800, a first column 802 indicates various types of materials, while a second column 804 indicates whether vibration may or should be reduced based on the corresponding material being detected and/or determined. Thus, the logic of FIG. 7 may access the table 800 once a material has been detected and/or determined to compare the detected and/or determined material to the materials in the table 800. Once the logic matches the detected and/or determined material to a material in the first column 802, the logic may determined based on the corresponding information for the respective entry in column 804 whether e.g. vibration may or should be reduced and/or altered from a level and/or pattern at which it would otherwise vibrate.

Thus, as may be appreciated from the table 800, wood, metal, plastic, glass, and composite materials (e.g. composite wood materials, composite metal materials, etc.) are all materials for which vibration may or should be e.g. altered or reduced, whereas cloth (e.g. a person's clothing), organic matter materials (e.g. a portion of a human body), and other relatively “softer” materials are materials for which vibration may or should not be otherwise e.g. altered or reduced. Thus, it may be appreciated from FIGS. 7 and 8 that e.g. should a device undertaking the logic of FIG. 7 be in a person's pocket, it may be determined that vibration may not be altered or reduced, whereas should the device be in contact with another surface such as a glass coffee table, it may be determined that vibration may or should be altered or reduced to thus avoid annoyances and/or disturbances caused by the vibration of the device against the coffee table. Before describing FIG. 9, note that other ways of detecting materials contacting or near the device may be used in accordance with present principles without affecting them.

Continuing the detailed description in reference to FIG. 9, it shows example logic that may be undertaken by a device such as the system 100 in accordance with present principles. Beginning at block 900, the logic receives an incoming communication. The logic then proceeds to block 902 where the logic (e.g. requests and) receives input from a camera and/or light sensor on the device. The logic then proceeds to decision diamond 904 where, based on the input that is received at block 902, the logic determines whether (e.g. ambient) light is at or above a threshold amount and/or level of light. A negative determination causes the logic to proceed to block 906, at which the logic actuates (and/or continues actuating) a vibrating element on the device at a first level and/or first pattern. However, responsive to an affirmative determination at diamond 904, the logic instead proceeds to block 908, at which the logic actuates the vibrating element at a second level and/or second pattern respectively different from the first level and first pattern, such as e.g. actuating the vibrating element at a vibration level less than the first level and/or a pattern of vibrations separated by pauses in vibration. It may thus be appreciated that the logic of FIG. 9 may be used to determine a vibration level based on light such that e.g. when the device is in a user's pocket or otherwise in a relatively low-light environment, vibration may occur as it otherwise normally would (e.g. per default vibration settings) but when the device is e.g. placed on a table where ambient light is relatively high, vibration may occur at a lesser level than it otherwise would.

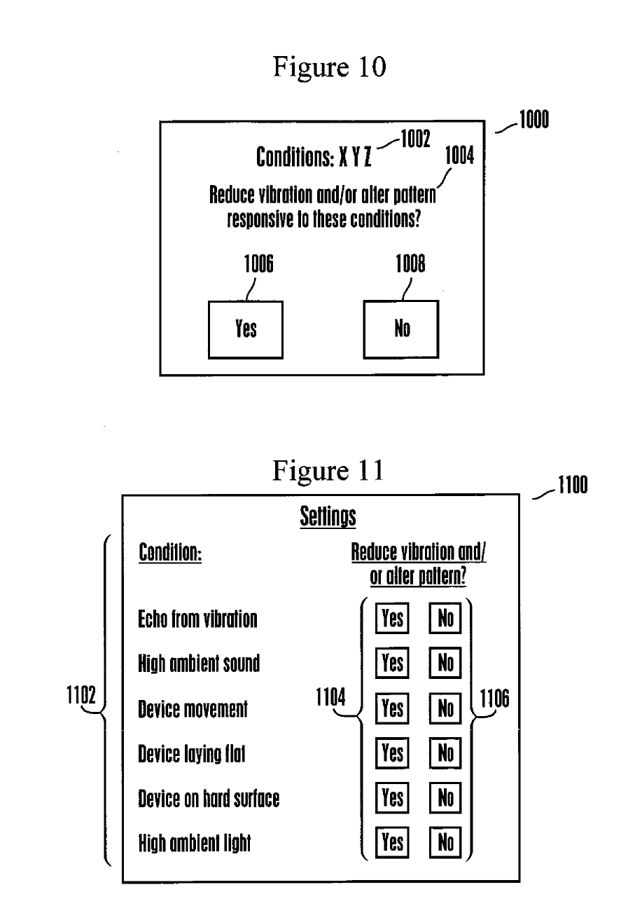

Moving on, reference is now made to FIG. 10, which shows a UI 1000 presentable on a device such as the system 100. The UI 1000 may be presented e.g. responsive to any of the determinations described above, and/or based on input from a user to configure vibration settings for the system 100, and/or responsive the system 100 e.g. actuating its vibrating element at either a first level or second level (and/or first pattern or second pattern) based on the determinations discussed above in accordance with present principles. In any case, the UI 1000 includes an indication of one or more conditions that exist as detected by the device (e.g., one or more of any of the conditions described herein such as the device being disposed in an area with relatively low ambient light that is less than a threshold level, based on movement of the device at an acceleration less than a threshold level, based on the device lying flat on a surface, etc.). Thus, it is to be understood that the UI 1000 may at indication 10002 indicate a combination of conditions and that input to the UI 1000 as will be described immediately below may be used to configure the device according to the input for the specific combination of conditions indicated at indication 1002.

Thus, the UI 1000 includes a prompt 1004 prompting the user for whether to reduce vibration of the device and/or alter the vibration pattern responsive to the conditions indicated in indication 1002 occurring (e.g. in the present and/or in the future when the conditions exist again). Responsive to selection of the yes selector element 1006, the device may automatically without further user input responsive thereto configure the device to reduce vibration of the device and/or alter the vibration pattern responsive to the conditions indicated indication 1002 occurring, while selection of the no selector element 1008 may cause the device to automatically without further user input responsive thereto configure the device to decline to reduce vibration of the device and/or alter the vibration pattern responsive to the conditions indicated indication 1002 occurring.

Reference is now made to FIG. 11, which shows an example settings UI 1100 that may be presented on a device such as the system 100 in accordance with present principles. The settings UI 1100 includes plural settings 1102 corresponding to different conditions that when detected and/or determined by the device may cause e.g. a reduction or alteration to vibration levels and/or patterns that would otherwise be used by the device. Accordingly, each of the settings 1102 has respective yes selector elements 1104 and no selector elements 1106 for respectively providing affirmative or negative input to the device to automatically without further user input responsive thereto configure the device either reduce or alter vibration responsive to the device detecting and/or determining existence of the corresponding condition, or configure the device to decline to reduce or alter vibration responsive to the device detecting and/or determining existence of the corresponding condition.

Thus, as may be appreciated from the UI 1100, example conditions for which settings may be configured to either e.g. reduce vibration lower than a default level or decline to so reduce include existence of an echo caused by vibrations of the device, relatively high ambient sound (e.g. above a sound threshold), device movement (e.g. higher than a movement threshold), the device laying flat and/or still (e.g. on a surface), the device being positioned at least partially against a relatively hard surface (e.g. a metal object), and relatively high ambient light (e.g. above a light threshold).

Without reference to any particular figure, it is to be understood that e.g. the detection of and determination(s) based on sounds as detected by a microphone in accordance with present principles may be based on the harmonic buildup, amplitude, and/or frequency of the sound(s), and/or the type of noise (e.g. using a data table to match noise types to whether or not to alter vibrations in accordance with present principles).

What's more, present principles recognize that cameras may be used in accordance with present principles in still other ways. E.g., a camera on a device may be an infrared and/or thermal imaging camera which may detect the presence of e.g. plural people nearby and/or within a predetermined distance or area from the device (e.g. as set by a user), and e.g. responsive to detecting plural users instead of a single person (e.g. whom may be the user of the device) the device may determine that vibrations may or should be reduced (e.g. so as to not disturb people in the predefined area). The same principles may apply to e.g. signals from a webcam on the device gathering images which a processor of the device may then use to determine e.g. based on facial recognition and/or object recognition the number of people in a predetermined area. E.g., if the camera gathers images which when analyzed by the processor are used to determine that plural people are within a predefined area such as e.g. all sitting in a living room, the device may determine to reduce a vibration level for the device and/or alter a vibration pattern so as to not disrupt the individuals in the predefined area with intrusive vibration noise. Similarly, other devices in the predefined area may also be detected (e.g. based on images from a camera, based on network communication between the devices, and/or based on GPS coordinates for the other devices for which the device has access) and e.g. responsive to plural devices being detected in the predefined area the device may determine to reduce a vibration level for the device and/or alter a vibration pattern.

Also without reference to any particular figure, in accordance with present principles note that in some embodiments where a determination is made that e.g. the level, intensity, and/or magnitude of vibration from a vibrating element may or should be altered, it may be altered by increasing the level, intensity, and/or magnitude rather than decreasing it. Thus, based on determinations that e.g. the device is in a dark place but is also undergoing relatively high motion changes (and hence it may be difficult for the individual to feel or otherwise sense the vibration such as in a person's pocket while exercising), vibration level, intensity, and/or magnitude may be increased rather than decreased, thus making it easier for the person to feel or otherwise sense the vibration to e.g. thus answer a telephone call.

Furthermore, it is to also be understood that the determinations based on any of the thresholds described herein may be opposite in that e.g. rather than determining that acceleration is less than a threshold it may be determined whether acceleration is more than a threshold in other embodiments. The same may apply to the other thresholds and determinations discussed herein, mutatis mutandis.

In addition, it is to be understood that although e.g. a software application for undertaking present principles may be vended with a device such as the system 100, present principles apply in instances where such an application is e.g. downloaded from a server to a device over a network such as the Internet.

It may now be appreciated based on present principles that e.g. reducing the vibration level and/or altering the vibration pattern such that the total time and/or intensity at which the device vibrates within a predetermined time may be reduced to thus reduce and/or eliminate the (e.g. audible) noise produced by the vibration and hence cause less if any distraction to a nearby person that would otherwise be distracted by the device vibrating at its e.g. default vibration level and/or pattern. Furthermore, present principles recognize that when altering vibration from e.g. a first level to a second level, the vibration level may incrementally be reduced over time (e.g. half a second) from the first level to the second level.

While the particular ACTUATING VIBRATION ELEMENT ON DEVICE BASED ON SENSOR INPUT is herein shown and described in detail, it is to be understood that the subject matter which is encompassed by the present application is limited only by the claims.

1. A device, comprising:
a vibration element;
a microphone;
an accelerometer;
a processor; and
a memory accessible to the processor and bearing instructions executable by the processor to:
actuate the vibration element at a first vibration level;
determine, based on input from an input device selected from the group consisting of the microphone and the accelerometer, whether the input conforms to a first parameter; and
responsive to a determination that the input conforms to the first parameter, reduce vibration from the first level to a second level.

2. The device of claim 1, wherein the determination of whether the input conforms to a first parameter is based at least on input from the microphone, and wherein the parameter is sound of at least a threshold amount.

3. The device of claim 1, wherein the determination of whether the input conforms a first parameter is based at least on input from the accelerometer, and wherein the parameter is movement below a threshold amount.

4. The device of claim 1, wherein the vibration element is activated at the first vibration level responsive to receipt of an incoming communication at the device.

5. The device of claim 1, wherein the instructions are further executable to, responsive to a determination that the input does not conform to the first parameter, continue to actuate the vibration element at the first vibration level for a predetermined amount of time.

6. A method, comprising:
actuating, at a device, a vibration element using a first vibration pattern;
determining, based on input from at least one sensor, whether the input conforms to a first parameter; and
responsive to determining that the input conforms to the first parameter, altering actuation of the vibration element to a second vibration pattern different from the first vibration pattern.

7. The method of claim 6, wherein the first vibration pattern is constant vibration, and wherein the second vibration pattern is vibrations of predetermined lengths of time respectively separated by periods of no vibrations, the periods of no vibrations being of predetermined lengths of time.

8. The method of claim 6, wherein the method further comprises, responsive to determining that the input does not conform to the first parameter, continuing to actuate the vibration element using the first vibration pattern.

9. A device, comprising:
at least one sensor;
a vibration element;
a processor; and
a memory accessible to the processor and bearing instructions executable by the processor to:
receive input from the sensor;
determine, based on the input from the sensor, whether an attribute detected by the sensor conforms to a first parameter; and
responsive to a determination that the attribute detected by the sensor conforms to the first parameter, actuate the vibration element to vibrate at a first magnitude.

10. The device of claim 9, wherein the sensor is a microphone, wherein the attribute is sound level, and wherein the first parameter is selected from the group consisting of: sound at a threshold level, sound above the threshold level.

11. The device of claim 9, wherein the sensor is a microphone, wherein the attribute is sound type, and wherein the first parameter is a sound type selected from the group consisting of: an echo, a reverberation.

12. The device of claim 9, wherein the sensor is an accelerometer, wherein the attribute is movement amount of the device, and wherein the first parameter is selected from the group consisting of: movement at a threshold amount, movement below the threshold amount.

13. The device of claim 12, wherein the first parameter is movement at a threshold amount, and wherein the threshold amount is zero.

14. The device of claim 9, wherein the sensor is a gyroscope, wherein the attribute is orientation of the device, and wherein the first parameter is orientation of the device such that a display of the device establishes a plane substantially orthogonal to an axis established by the direction of the Earth's gravity at the first device.

15. The device of claim 9, wherein the sensor is an ultrasound transceiver, wherein the attribute is material, and wherein the first parameter is selected from the group consisting of: a wood, a metal, a plastic, a glass, a composite.

16. The device of claim 9, wherein the sensor is selected from the group consisting of: a camera, a light sensor;
wherein the attribute is light amount; and
wherein the first parameter is selected from the group consisting of: light at a threshold amount, light above the threshold amount.

17. The device of claim 9, wherein the instructions are further executable to, responsive to a determination that the attribute does not conform to the first parameter, actuate the vibration element to vibrate at a second magnitude different than the first magnitude.

18. The device of claim 9, wherein responsive to receipt of an incoming communication at the device and prior to the determination of whether the input conforms to the first parameter, the vibration element is actuated to vibrate at a second magnitude different from the first magnitude.

19. The device of claim 18, wherein the second magnitude is greater than the first magnitude.

20. The device of claim 18, wherein the second magnitude is less than the first magnitude.
